(19) United States
(12) Patent Application Publication
(10) Pub. No.: US 2006/0276318 A1
(43) Pub. Date: Dec. 7, 2006

(54) Method for manufacturing paper containers

(76) Inventors: Yukihide Saitoh, Shizuoka-ken (JP); Hiroshi Suzuki, Shizuoka-ken (JP)

Correspondence Address: WENDEROTH, LIND & PONACK, L.L.P., 2033 K STREET N. W., SUITE 800, WASHINGTON, DC, 20006-1021, US

(21) Appl. No.: 11/439,237

(22) Filed: May 24, 2006

(30) Foreign Application Priority Data
Jun. 2, 2005 (JP) 2005-162652

(51) Int. Cl. B31B 1/00

(52) U.S. Cl. 493/68

(57) ABSTRACT

To provide a method for manufacturing a paper container, which can properly form a curved shape to bulge the bottom sheet of the paper container in an arch or sphere shape into a containing portion. The method manufactures the paper container, in which a bottom sheet and four side sheets rising from the bottom sheet form the containing portion opened upward and in which the bottom sheet is formed to have a curved sheet bulging in the arch or sphere shape into the containing portion. A block having four side faces for regulating the inner faces of the four side sheets is used to fold the four side sheets of an extended blank sheet of the paper container downward so as to push the four side sheets onto the four side faces of the block thereby to form the rising state. The bottom sheet is sucked downward by a suction cup mounted in the block, thereby to bend the bottom sheet into a curved state to bulge in the arch or sphere shape into the containing portion.

### BACKGROUND OF THE INVENTION

1. Field of the Invention

The present invention relates to a method for manufacturing a paper container, in which a containing portion opened upward is formed by a bottom sheet and four side sheets rising from the four sides of the bottom sheet and in which the bottom sheet has a shape curved in an arch or sphere shape into the containing portion.

2. Background Art

There has been well known a paper container, which can be stably disposed either at the four points of the corner portions of a curved bottom sheet or at confronting two sides by forming the bottom sheet in a curved shape into the containing portion of the container, thereby to intensify the strength of the bottom sheet against the weight of the contents.

Documents 1 to 4 disclose a paper container, in which the upward open containing portion is formed by four side sheets rising from the four sides of the bottom sheet and in which the bottom sheet shows such as shape as is curved in an arch or sphere shape into that containing portion. This paper container, which has the bottom sheet formed in the arch or sphere shape, as disclosed in Patent Documents 1 to 4, has the following constitutions a to c.
a. The four sides or two confronting sides of the bottom sheet are curved to bulge to the outer sides.
b. The paper container has four side sheets raised from the four sides of that bottom sheet so that the upward open containing portion is defined by the bottom sheet and the four side sheets.
c. At least two confronting side sheets are formed of curved sheets bulging to the outer sides, and the bottom sheet is formed of the curved sheet to bulge in the arch or sphere shape into the containing portion.

Patent Document 1: JP-UM-A-62-197517

Patent Document 2: JP-UM-A-7-37975

Patent Document 3: JP-A-8-324542

Patent Document 4: JP-A-2000-33934

### SUMMARY OF THE INVENTION

In the paper container, as described hereinbefore, the bottom sheet is formed in the curved shape to bulge into the containing portion so that the weight of contents in the containing portion is loaded concentratedly at the two sides or four corner portions of the bottom sheet and so that the paper container can be stably disposed at the two sides or four corner portions without being grounded at the bottom sheet.

Moreover, the bridging strength of the bottom sheet can be improved to solve such a problem as much as possible that the bottom sheet is warped downward while being carried, by the weight of the contents.

In case, however, the paper container is to be formed by pushing the four side sheets downward from its extended blank sheet, the curved shape, in which the bottom sheet bulges into the containing portion, is not necessarily obtained, but the bottom sheet has to be manually shaped.

On the means for bulging the bottom sheet reliably into the containing portion of the container, no indication is made by Patent Documents 1 to 4. The desired proposition is the method for shaping the bottom sheet into a bulged state so as to be reliably bulged into the containing portion, at the step of folding the extended blank sheet thereby to execute the purpose properly.

The present invention contemplates to provide a method for manufacturing a paper container, which can obtain a bottom sheet of a predetermined curved shape in an extended blank sheet properly while folding four side sheets from the bottom sheet.

In this paper container manufacturing method, there are used a block, which has four side faces for regulating the four side sheets of the extended blank sheet for constituting the paper container, and a suction cup which is assembled in the block.

In short, the four side sheets of an extended blank sheet of the paper container, as extended four ways from the bottom sheet, are folded downward so as to be pushed onto the four side faces of the block thereby to form the rising state, and the four gusset sheets are pushed onto and adhered to the outer surfaces of the confronting paired side sheets in the rising state, thereby to form the containing portion.

The bottom sheet is sucked downward, in the procedure to form the containing portion, by a suction cup mounted in the block, thereby to bend the bottom sheet into a curved state to bulge in the arch or sphere shape into the containing portion.

The curved state is formed in the containing portion of the bottom sheet, and the four side sheets or the confronting two side sheets are accordingly formed into the curved state to bulge to the outer sides and are held in the curved state.

According to the aforementioned method, the paper container can properly form the curved shape to bulge the bottom sheet of the paper container in the arch or sphere shape into the containing portion, and can form the bottom sheet into the curved shape to concentrate the load of the contents on the two sides or at the four corner portions of the bottom sheet thereby to dispose the paper container stably and to enhance the strength of the bottom sheet against the weight of the contents.

Moreover, either the four side sheets or the two side sheets are formed into the bulging state to bulge out to the outer sides so that they can closely fit on the cover member to be fitted on the upper face opening of the container.

### BRIEF DESCRIPTION OF THE DRAWINGS

FIG. 1 is a top plan view of an extended blank sheet of a first paper container;

FIG. 2 is a top plan view of an extended blank sheet of a second paper container;

FIG. 3 is a side elevation of the first or second paper container;

FIG. 4 is a top plan view of the first paper container;

FIG. 5 is a top plan view of the second paper container;

FIG. 6 is a sectional view of the first paper container;

FIG. 7 is a sectional view of the second paper container;

FIG. 8 is a perspective view of a block for holding the first paper container;

FIG. 9 is a perspective view of a block for holding the second paper container;

FIGS. 10A and 10B are side elevations showing an apparatus for applying an adhesive to the first or second paper container, in the sequence of steps;

FIG. 11 is a top plan view showing the adhesive applied positions of the expanded blank sheet of the first paper container and the supported state of the same sheet by the block;

FIG. 12 is a top plan view showing the adhesive applied positions of the expanded blank sheet of the second paper container and the supported state of the same sheet by the block;

FIG. 13 is a side elevation showing an apparatus for holding the individual expanded blank sheet of the first or second paper container;

FIGS. 14A to 14E are sectional views showing the individual expanded blank sheet holding and bottom sheet bending steps sequentially by the block, a suction cup and guide poles;

FIGS. 15A to 15C are top plan views showing a holding step of the expanded blank sheet of the first paper container and an adhering step of the gusset sheet by the guide poles in the order of the steps;

FIGS. 16A to 16C are top plan views showing a holding step of the expanded blank sheet of the first paper container and an adhering step of the gusset sheet by the guide poles in the order of the steps;

FIG. 17 is a perspective view showing the state, in which the bottom sheet of the first paper container is bent into an arch shape by the suction cup;

FIG. 18 is a perspective view showing the state, in which the bottom sheet of the second paper container is bent into a sphere shape by the suction cup;

FIG. 19 is a top plan view showing the block having the suction cup assembled therein;

FIG. 20 is a sectional view showing the block having the suction cup assembled therein;

FIG. 21 is a top plan view showing another example of the block having the suction cup assembled therein; and

FIG. 22 is a sectional view showing that another example of the block having the suction cup assembled therein.

### DESCRIPTION OF THE PREFERRED EMBODIMENTS

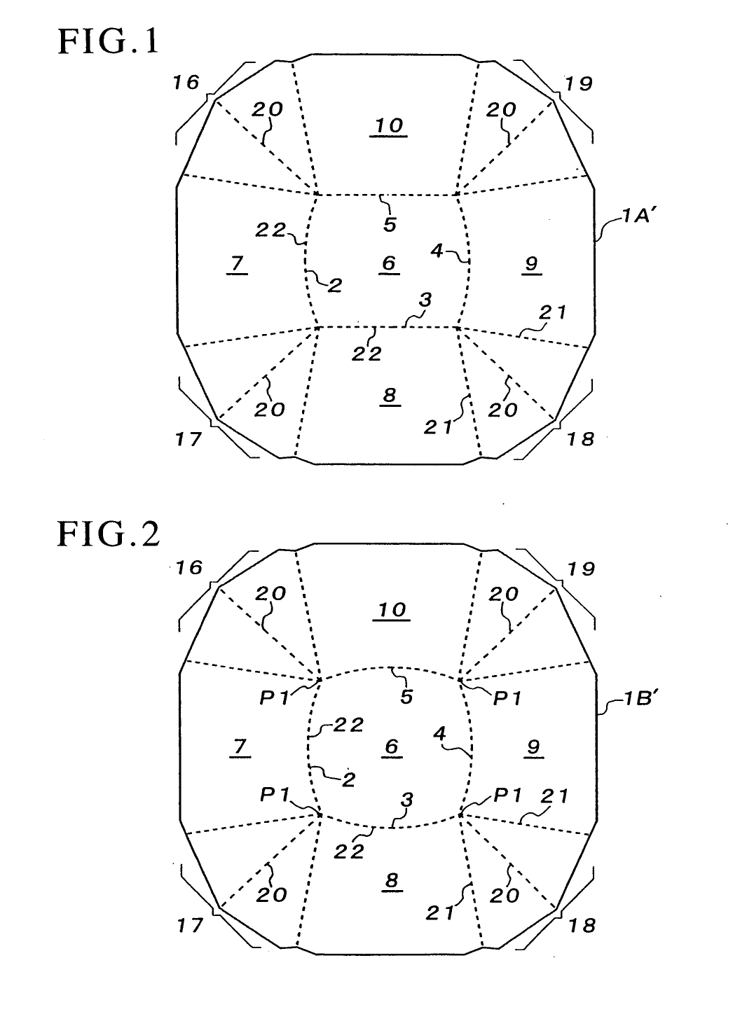

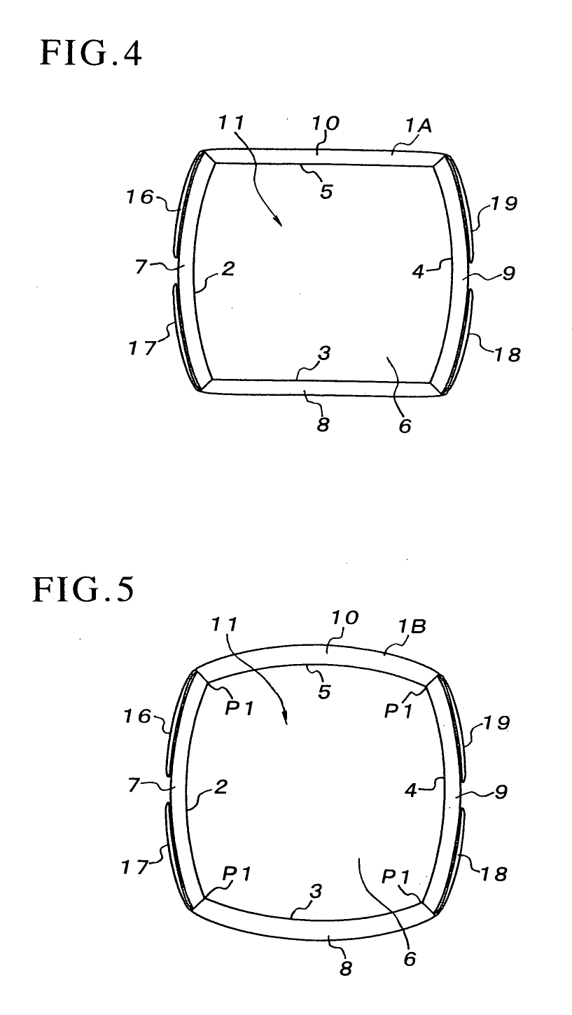

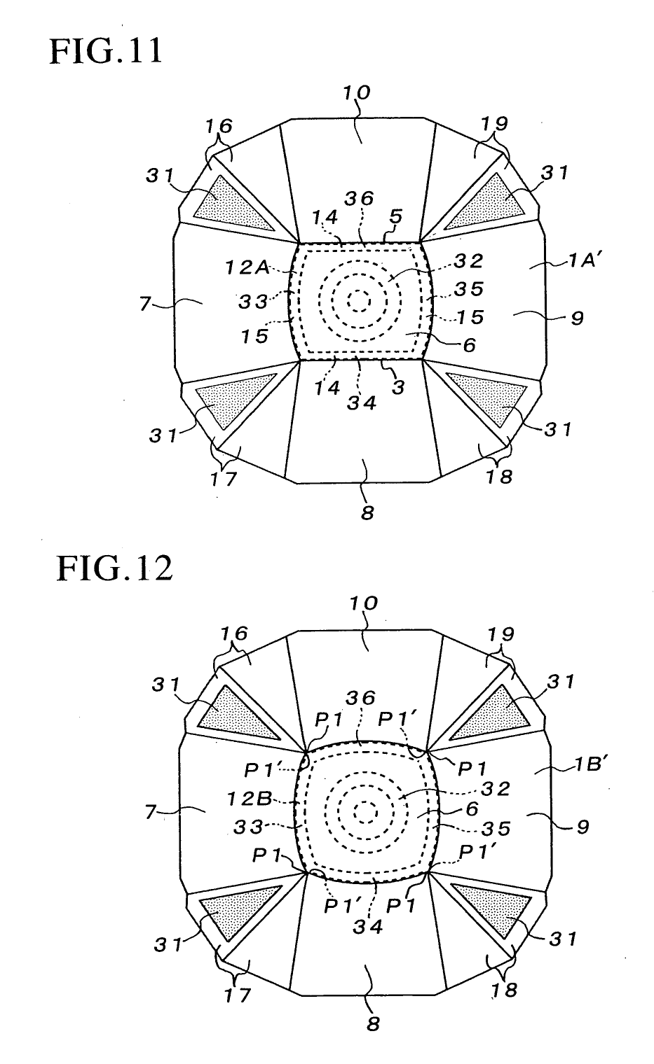

The best mode for carrying out the invention will be described with reference to FIG. 1 to FIG. 22.

As described hereinbefore, a paper container 1A or 1B has an upward opened containing portion 11 formed by a bottom sheet 6 and four side sheets 7 to 10 rising from the four sides 2 to 5 of the bottom sheet 6. This bottom sheet 6 is formed of a curved sheet to bulge in an arch or sphere shape into the containing portion 11. The paper container 1A or 1B has four gusset sheets 16 to 19, which are connected to the side sheets adjoining each other at the four corner portions of the containing portion 11 and which are folded on and adhered to the outer surfaces of the paired confronting side sheets 7 and 9.

The paper container 1A or 1B is formed to bulge into the containing portion 11 thereof, so that it is enhanced in strength against the containing portion 11 and can be stably placed either at four points P1 of the corner portions of the curved bottom sheet 6 or at the confronting two sides 3 and 5. Moreover, either the four side sheets 7 to 10 or the confronting two side sheets 7 and 9 are formed into the bulging state to bulge out to the outer sides so that they can closely fit on the cover member at their upper ends.

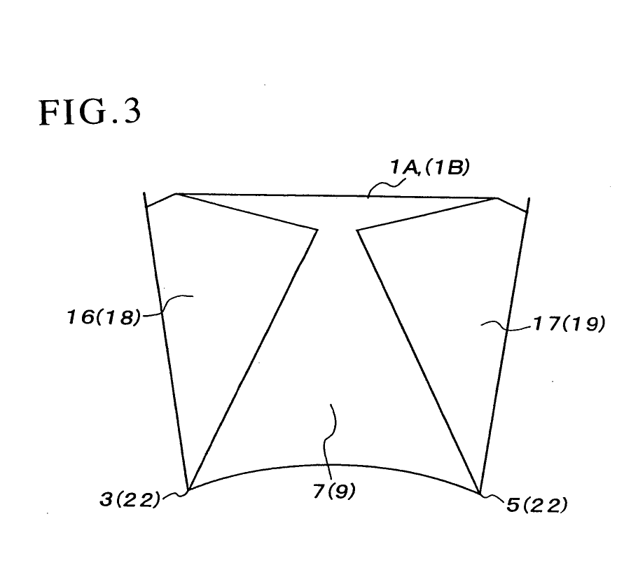

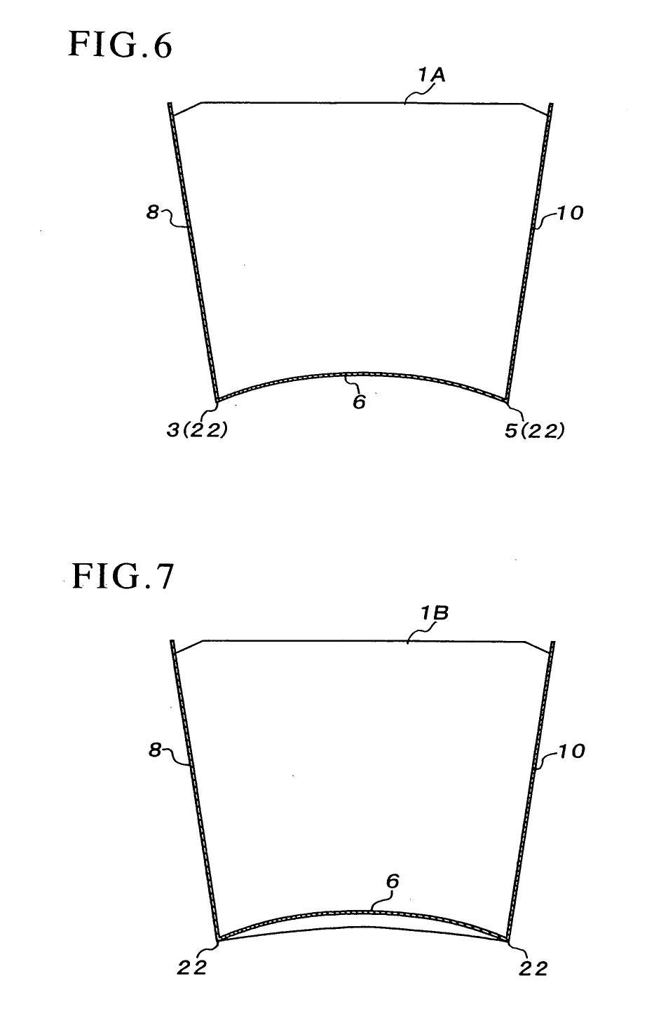

Specifically, the first paper container 1A having its bottom sheet 6 bulged in the arch shape has the following constitutions a to f (as referred to FIG. 1, FIG. 3 and FIG. 6).
a. The first paper container 1A includes the bottom sheet 6, of which: the confronting first and third sides 2 and 4 are formed into curved sides to symmetrically bulge out to the outer sides; and the remaining confronting second and fourth sides 3 and 5 are formed into straight sides parallel to each other, so that the bottom sheet 6 can elastically warp vertically.
b. The first paper container 1A includes the first to fourth side sheets 7 to 10, which are raised from the first to fourth sides 2 to 5 of the bottom sheet 6 and connected to each other. The bottom sheet 6 and the first to fourth side sheets 7 to 10 define the containing portion 11 opened upward. The first to fourth side sheets 7 to 10 can elastically warp inward and outward.
c. The first paper container 1A includes the first to fourth gusset sheets 16 to 19, which are formed continuously between the adjoining ones of the first to fourth side sheets 7 to 10 and which are folded on and adhered to the outer surfaces of the confronting first and third side sheets 7 and 9.
d. The fourth side sheets 7 to 10 have an inverted trapezoidal shape, which gradually diverges from the first to fourth sides 2 to 5 of the bottom sheet 6 toward their upper ends. In short, the inverted trapezoidal shape has folding lines 21 as their oblique lines.
e. The two confronting side sheets 7 and 9 are formed into the curved sheets to bulge out to the outer sides.

The first and third side sheets 7 and 9 rising from the first and third sides 2 and 4 of the curved lines are so curved over their substantially all heights as to bulge outward, and the second and fourth side sheets 8 and 10 rising from the second and fourth sides 3 and 5 of the straight lines are formed substantially flat.
f. The bottom sheet 6 is curved in the arch shape into the containing portion 11 between the second and fourth sides 3 and 5 of the straight lines. As a result, the first and third sides 2 and 4 exhibit the curved shape to bulge in upward.

The container 1A is supported at its second and fourth sides 3 and 5 of the straight lines on an installation face, and the first and third sides 2 and 4 and the bottom sheet 6 are placed in the state floating above the installation face.

As shown in FIG. 1, the first to fourth side sheets 7 to 10 in the first paper container 1A thus far described show the inverted trapezoidal shape, which is narrow on the side of the bottom sheet 6 and grows gradually wider toward the upper end edge. The first to fourth gusset sheets 16 to 19, which are arranged between the adjoining side sheets 7 to 10, show a delta shape.

Each of the first to fourth gusset sheets 16 to 19 is divided into two delta sheets by a center folding line 20 terminating at the corner portion P1 of the bottom sheet 6. Those delta sheets are folded in two along the center folding line 20, and the inner ones of the folded delta sheets are adhered to the outer surfaces of the first and third side sheets 7 and 9 rising from the curved sides 2 and 4. These adhesions keep the curved shapes of the first and third side sheets 7 and 9 to bulge out and the curved state of the bottom sheet 6 in the arch shape.

Likewise, the folding line 21 terminating at the corner portion P1 exists between each of the side sheets 7 to 10 and each of the gusset sheets 16 to 19, and a folding line 22 extending over the four sides 2 to 5 of the bottom sheet 6 exists between each side sheets 7 to 10 and the bottom sheet 6.

Each of the side sheets 7 to 10 is raised through the folding line 22 from each of the four sides 2 to 5 of the bottom sheet 6, and each of the gusset sheets 16 to 19 is folded in two through the folding line 21 outward from the corner portion P1 of each of the side sheets 7 to 10 and is expanded out so that it is adhered to the outer surface of each of the first and third side sheets 7 and 9.

The first paper container 1A is formed into an extended blank sheet 1A′ of a flat sheet, as shown in FIG. 1, by opening the first to fourth gusset sheets 16 to 19.

Next, the second paper container 1B having its bottom sheet 6 bulged in the sphere shape into the containing portion 11 has the following constitutions a to f (as referred to FIG. 2, FIG. 3 and FIG. 7).
a. The first paper container 1B includes the bottom sheet 6, of which: the confronting first and third sides 2 and 4 are formed into curved sides to symmetrically bulge out to the outer sides; and the remaining confronting second and fourth sides 3 and 5 are formed into curved sides to symmetrically bulge out to the outer sides, so that the bottom sheet 6 can elastically warp vertically.
b. The first paper container 1B includes the first to fourth side sheets 7 to 10, which are raised from the first to fourth sides 2 to 5 of the bottom sheet 6 and connected to each other. The bottom sheet 6 and the first to fourth side sheets 7 to 10 define the containing portion 11 opened upward. The first to fourth side sheets 7 to 10 can elastically warp inward and outward.
c. The first paper container 1B includes the first to fourth gusset sheets 16 to 19, which are formed continuously between the adjoining ones of the first to fourth side sheets 7 to 10 and which are folded on and adhered either to the outer surfaces of the confronting first and third side sheets 7 and 9 or to the outer surfaces of the second and fourth side sheets 8 and 10.
d. The fourth side sheets 7 to 10 have an inverted trapezoidal shape, which gradually diverges from the first to fourth sides 2 to 5 of the bottom sheet 6 toward their upper ends. In short, the inverted trapezoidal shape has folding lines 21 as their oblique lines.
e. The first to fourth side sheets 7 to 10 are formed into the curved sheets to bulge out to the outer sides.

The first to fourth side sheets 7 to 10 rising from the first to fourth sides 2 to 5 of the curved lines are curved over their substantially all heights.
f. The bottom sheet 6 is formed of a curved sheet to bulge in a sphere into the containing portion 11. As a result, the first to fourth sides 2 to 5 exhibit the curved shape to bulge in upward.

The container 1B is supported at its four corner portions P1 of the bottom sheet 6 on the installation face, and the bottom sheet 6 and its four sides 2 to 5 are placed in the state floating above the installation face.

As shown in FIG. 2, the first to fourth side sheets 7 to 10 in the second paper container 1B thus far described show the inverted trapezoidal shape, which is narrow on the side of the bottom sheet 6 and grows gradually wider toward the upper end edge. The first to fourth gusset sheets 16 to 19, which are arranged between the adjoining side sheets 7 to 10, show a delta shape.

Each of the first to fourth gusset sheets 16 to 19 is divided into two delta sheets by a center folding line 20 terminating at the corner portion P1 of the bottom sheet 6. Those delta sheets are folded in two along the center folding line 20, and the inner ones of the folded delta sheets are adhered to the outer surfaces of the first and third side sheets 7 and 9 or the second and fourth side sheets 8 and 10. These adhesions keep the curved shapes of the first to fourth side sheets 7 to 10 and the spherically curved shape of the bottom sheet 6.

Likewise, the folding line 21 terminating at the corner portion P1 exists between each of the side sheets 7 to 10 and each of the gusset sheets 16 to 19, and a folding line 22 extending over the four sides 2 to 5 of the bottom sheet 6 exists between each side sheets 7 to 10 and the bottom sheet 6.

Each of the side sheets 7 to 10 is raised through the folding line 22 from each of the four sides 2 to 5 of the bottom sheet 6, and each of the gusset sheets 16 to 19 is folded in two through the folding line 21 outward from the corner portion P1 of each of the side sheets 7 to 10 and is expanded out so that it is adhered to the outer surface of each of the first and third side sheets 7 and 9 or each of the second and fourth side sheets 8 and 10.

The second paper container 1B is formed into an extended blank sheet 1B′ of a flat sheet, as shown in FIG. 2, by opening the first to fourth gusset sheets 16 to 19.

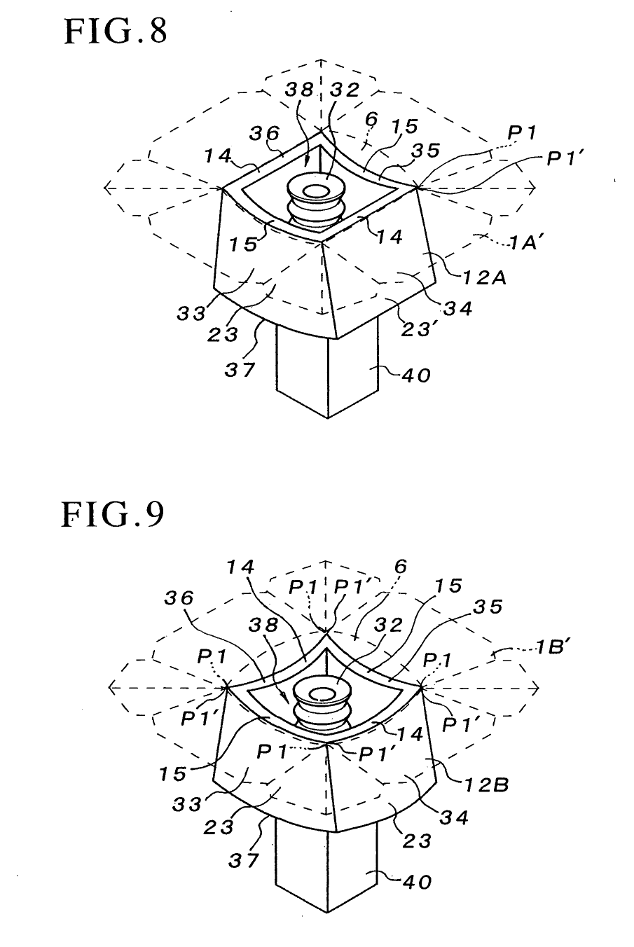

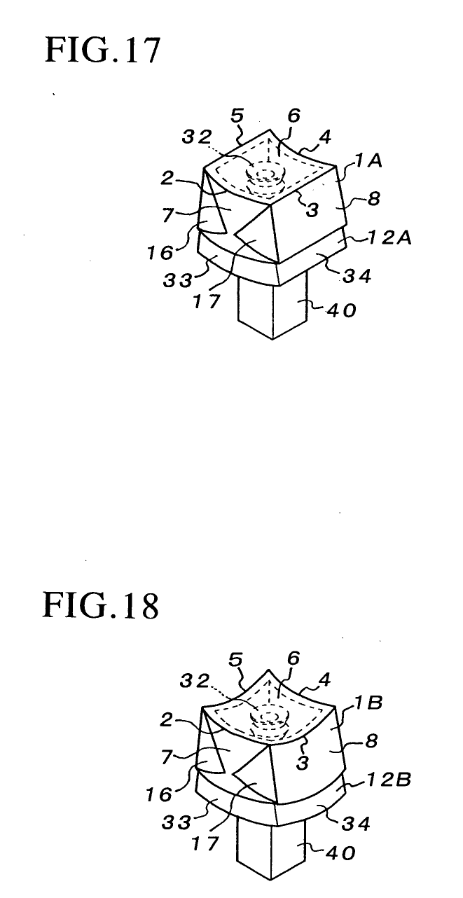

As shown in FIG. 8, FIG. 9, and FIG. 17 to FIG. 22, each of a block 12A for shaping the first paper container 1A and a block 12B for shaping the second paper container 1B has four side walls 33 to 36 and a bottom wall 37 to define a chamber 38 opened upward to show a box shape as a whole.

Four side faces 23 and 23′ of the four side walls 33 to 36 of the block 12A or 12B regulate the four side sheets 7 to 10. In other words, the block 12A or 12B has the four side walls 33 to 36, i.e., the four side faces 23 and 23′ for regulating the inner peripheries of the containing portion 11 of the paper container 1A or 1B.

The confronting two side walls 33 and 35 or two side faces 23 of the block 12A, as corresponding to the side sheets 7 and 9 of the aforementioned paper container 1A, are formed into a curved shape to bulge out, and the remaining confronting two side walls 34 and 36 or two side faces 23′ of the block 12A, as corresponding to the same side sheets 8 and 10, are formed into a flat face.

Upper end faces 14 of the two side walls 34 and 36 of the block 12A, as corresponding to the straight sides (i.e., the second and fourth sides) 3 and 5 of the bottom sheet 6 of the container 1A, are formed into straight faces, and upper end faces 15 of the two side walls 33 and 35 of the block 12A, as corresponding to the curved sides (i.e., the first and third sides) 2 and 4 of the bottom sheet 6, are formed into downward curved faces. When the four side sheets 7 to 10 are raised and shaped, the straight sides (i.e., the second and fourth sides) 3 and 5 of the bottom sheet 6 of the aforementioned extended blank sheet 1A′ are supported on the straight faces of the upper end faces 14 of the two side walls 34 and 36.

On the other hand, the four side walls 33 to 36 or the four side faces 23 and 23′ of the block 12B, as corresponding to the four side sheets 7 to 10 of the paper container 1B, are formed into curved shapes to bulge out.

On the other hand, the upper end faces 14 and 15 of the four side walls 33 to 36 of the block 12B, as corresponding to the four curved sides (i.e., the first to fourth sides) 2 to 5 of the bottom sheet 6 of the container 1B are formed into downward curved faces so that the container 1B is supported, when the four side sheets 7 to 10 are raised and shaped, at the four points of the four corner portions P1 of the extended blank sheet 1B′.

As shown in FIG. 17 to FIG. 22, a suction cup 32 is assembled into the aforementioned block 12A or 12B. In short, the suction cup 32 is assembled in that chamber 38.

The suction cup 32 has a bellows structure 41 in its circumferential wall so that it can vertically shrink and extend, and is made of a material having a flexibility.

The suction cup 32 is arranged to protrude its suction face upward from the open face of the aforementioned chamber 38, that is, to protrude upward from the upper faces of the block 12A or 12B, and is given a suction force through a suction pipe 39 extending through the bottom wall 37 of the block 12A or 12B.

Moreover, the bottom wall 37 of the block 12A or 12B is supported at its center portion by a shaft 40 so that the block 12A or 12B can be moved up and down together with the suction cup 32.

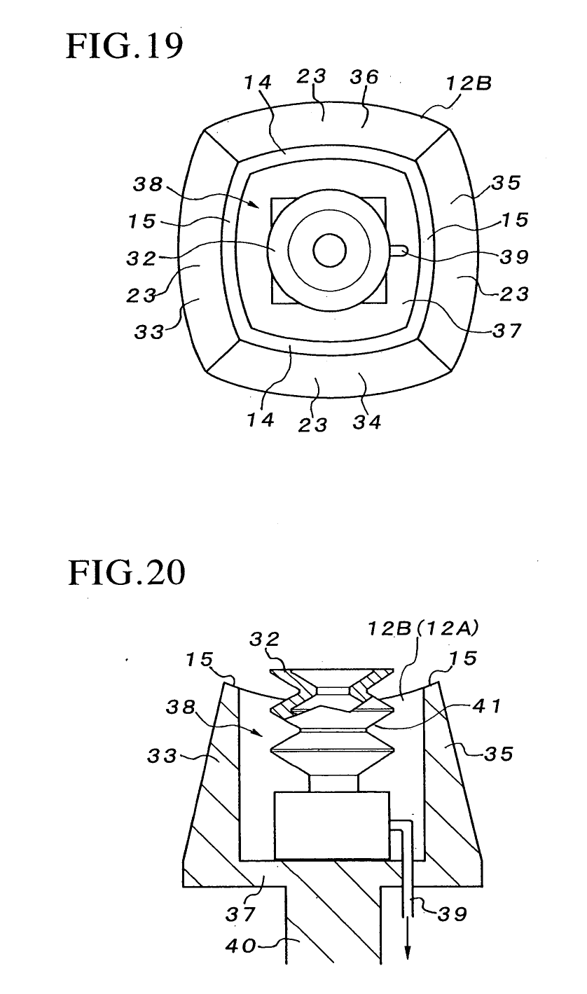

As shown in FIG. 19 and FIG. 20, the single suction cup 32 is arranged at the center portion in the chamber 38, i.e., at the center portion of the block 12A or 12B so that the upper end face, i.e., the suction face of the suction cup 32 is protruded upward by a predetermined extent from the open face of the chamber 38, i.e., from the upper end faces 14 and 15 of the four side walls 33 to 36.

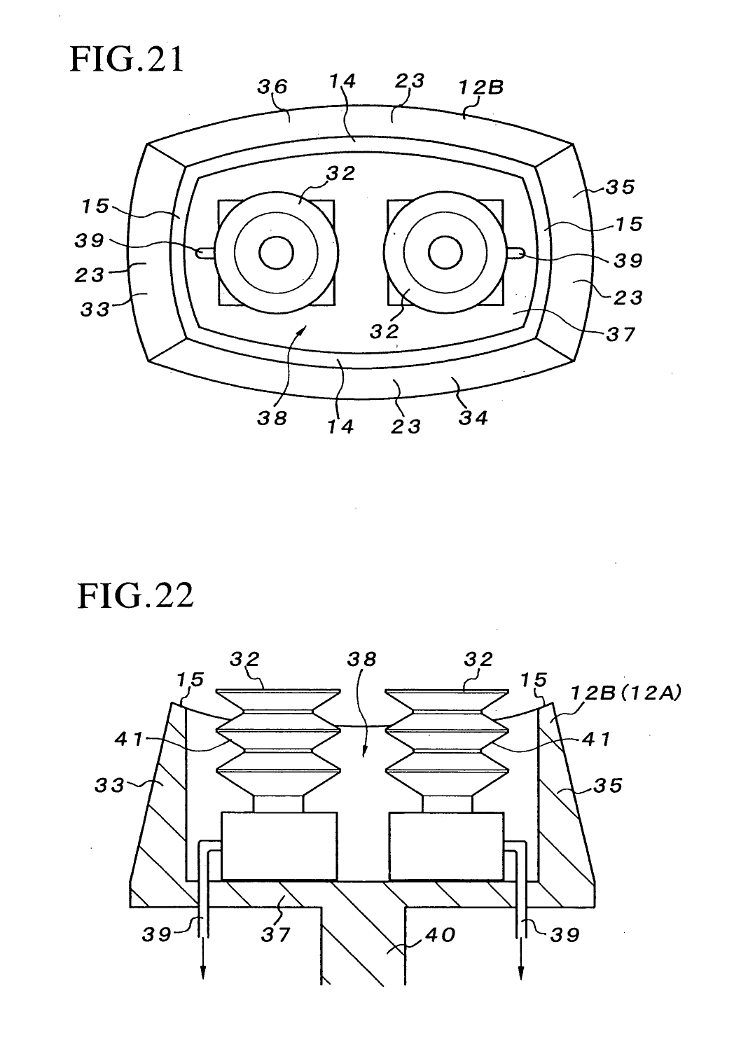

As shown in FIG. 21 and FIG. 22, alternatively, a plurality of suction cups 32 are so juxtaposed in the chamber 38 that their upper end faces, i.e., their suction faces are protruded upward by a predetermined extent from the open face of the chamber 38, i.e., the upper end faces 14 and 15 of the four side walls 33 to 36. The protrusions of the individual suction cups 32 from the open face of the chamber 38 are made substantially equal.

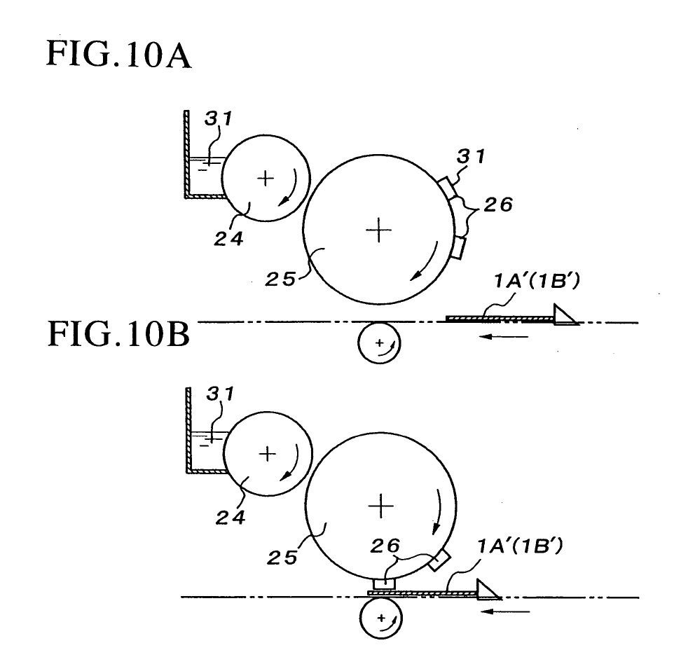

With reference to FIG. 10 to FIG. 16, the process for manufacturing the paper container 1A or 1B is described in the following.

As shown in FIGS. 10A and 10B, FIG. 11 and FIG. 12, an adhesive 31 is applied to the outer surface of one of the delta sheets to form the first to fourth gusset sheets 16 to 19 of the aforementioned extended blank sheet 1A′ or 1B′.

As shown in FIGS. 10A and 10B, for example, the adhesive is transferred by an adhesive transfer roller 24 to adhesive applying pads 26, which are arranged at a spacing to protrude from the circumference of an adhesive applying roller 25. The spacing between the adhesive applying pads 26 is set to that for applying the adhesive 31 to the outer surface of the aforementioned one delta sheet.

While the extended blank sheet 1A′ or 1B′, therefore, the adhesive 31 is applied to the outer surfaces of the one-side ones of the delta sheets forming the first to fourth gusset sheets 16 to 19, by the adhesive applying pads 26 as the individual adhesive applying roller 25 rotates.

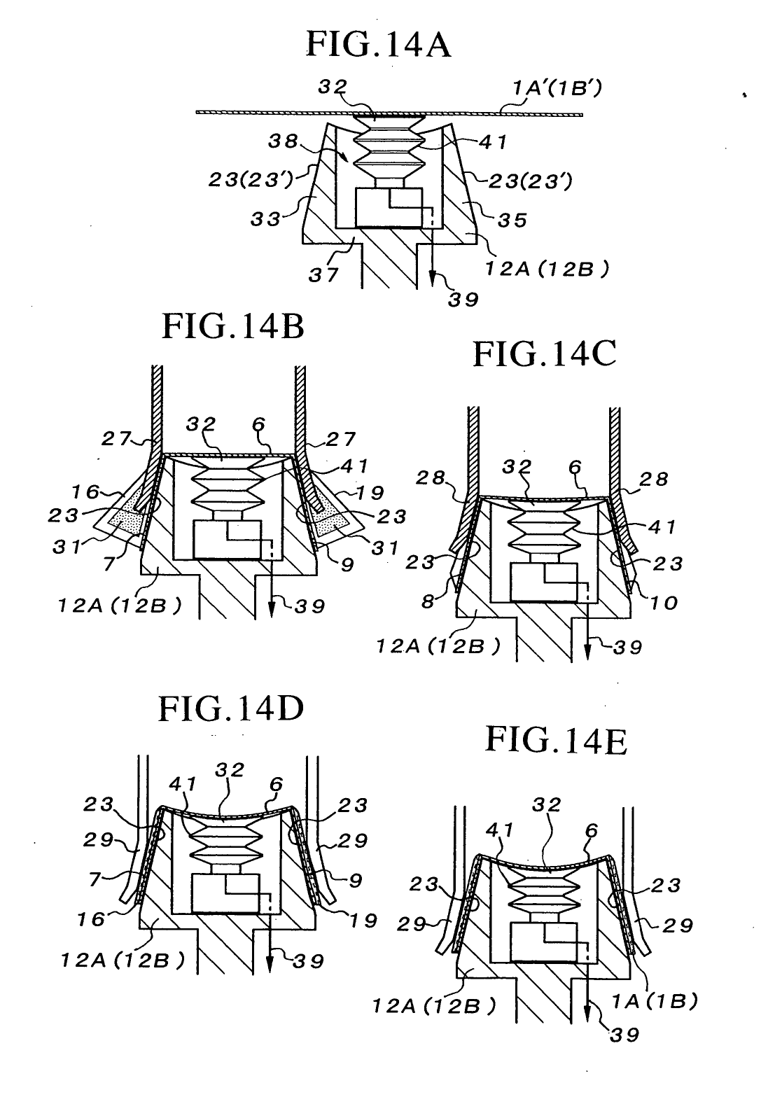

Next, as shown in FIG. 14A, the bottom sheet 6 of the extended blank sheet 1A′ or 1B′ is placed on the suction cup 32 of the aforementioned block 12A or 12B, so that the extended blank sheet 1A′ or 1B′ is horizontally supported. Specifically, the extended blank sheet 1A′ or 1B′ is so supported on the suction cup 32 as is spaced upward from the upper end faces 14 and 15 of the four side walls 33 to 36 of the block 12A or 12B, i.e., from the block 12A or 12B, and the bottom sheet 6 is sucked by the suction cup 32.

The first to fourth side sheets 7 to 10 and the first to fourth gusset sheets 16 to 19 are horizontally extended to the sides of the suction cup 32 and the four side walls 33 to 36 of the block 12A or 12B.

Next, as shown in FIG. 14B, the suction cup 32 shrinks downward due to its bellows structure 41, as its suction of the bottom sheet 6 proceeds, so that it supports the bottom sheet 6 on the block 12A or 12B in that shrinking procedure.

In the case of the extended blank sheet 1A′, specifically, the two straight sides (i.e., the second and third sides) 3 and 5 of the bottom sheet 6 are supported on the upper end faces 14 of the two side walls 34 and 36 of the block 12A.

In the case of the extended blank sheet 1B′, on the other hand, the four corner portions P1 of the bottom sheet 6 are supported on four corner portions P1′ of the block 12B.

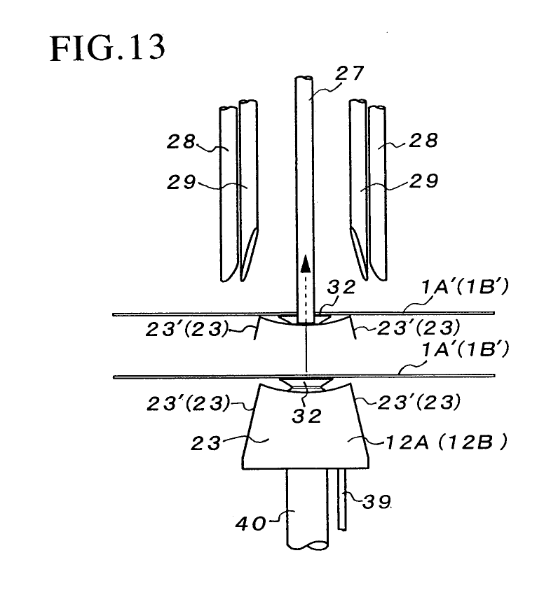

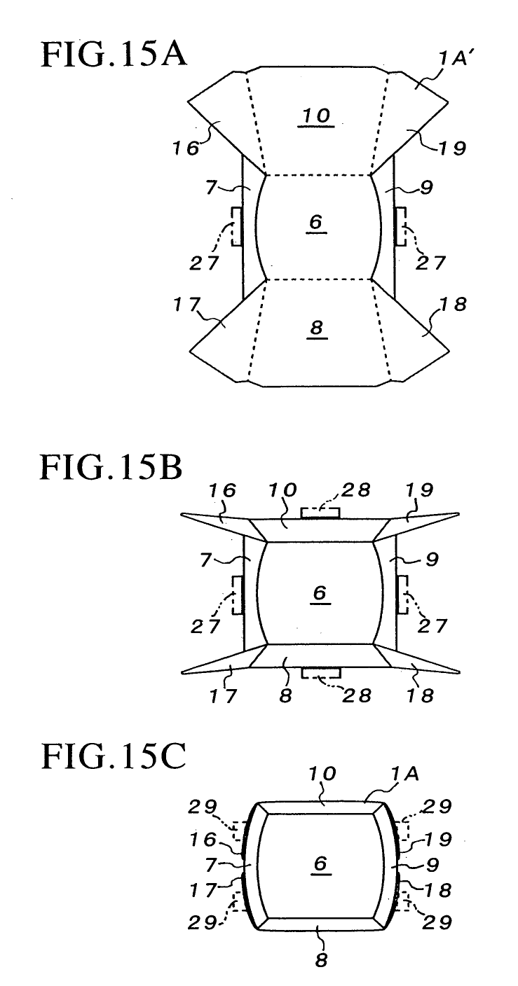

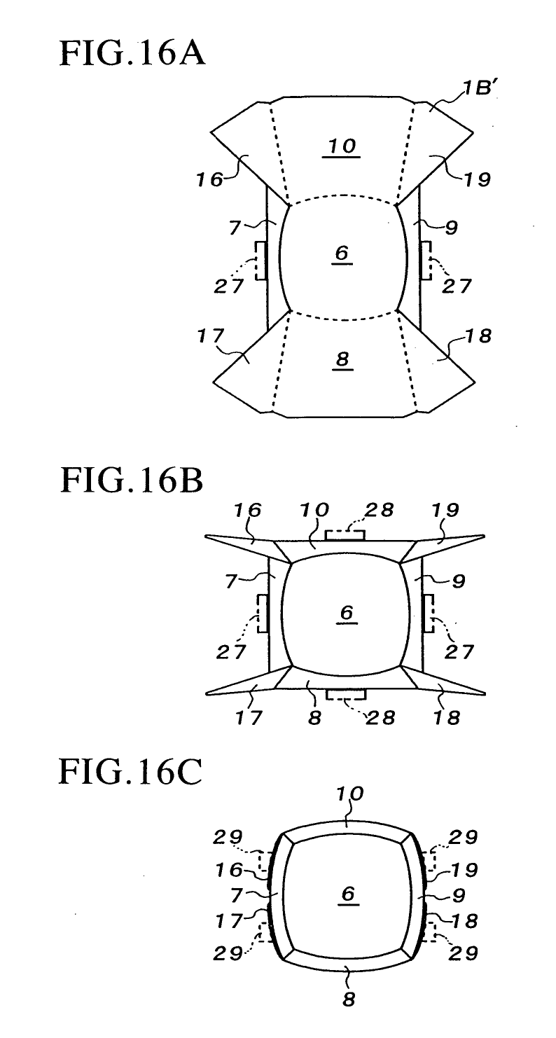

As shown in FIG. 13, FIG. 14B, FIG. 15A and FIG. 16A, the aforementioned block 12A or 12B is vertically lifted while the aforementioned extended blank sheet 1A′ or 1B′ is in a sucked state, and is pushed between first and second guide poles 27, which are disposed fixedly and vertically in the lifting direction of the block 12A or 12B and opposed to each other. The aforementioned first and third side sheets 7 and 9 or second and fourth side sheets 8 and 10 are relatively folded downward through the folding lines 22 and pushed onto the confronting two side faces 23 or 23′ of the block 12A or 12B.

Subsequently, as shown in FIG. 13, FIG. 14C, FIG. 15B and FIG. 16B, the block 12A or 12B is vertically lifted, and the extended blank sheet 1A′ or 1B′ is pushed with a time difference between third and fourth guide poles 28. Specifically, the block 12A or 12B is pushed between third and fourth guide poles 28, which are disposed fixedly and vertically in the lifting direction of the block 12A or 12B. The aforementioned second and fourth side sheets 8 and 10 or first and third side sheets 7 and 9 are relatively folded downward and pushed onto the remaining confronting two side faces 23′ or 23 of the block 12A or 12B. In this meanwhile, the regulations of the side sheets by the first and second guide poles 27 are held.

The lower ends of the first and second guide poles 27 are extended longer downward than those of the third and fourth guide poles 28 thereby to set the aforementioned folding time difference.

Next, as shown in FIG. 13, FIG. 14D, FIG. 15C and FIG. 16C, as the side sheets 7 to 10 are folded, the first to fourth gusset sheets 16 to 19 are folded in two and extended outward through the folding lines 20 and 21 from the corner portions of the adjoining side sheets.

Substantially simultaneously as the side sheets are folded by the third and fourth guide poles 28, the first to fourth gusset sheets 16 to 19 thus extended are pushed between fifth and sixth guide poles 29, which are disposed fixedly and vertically in the lifting direction of the block 12A or 12B. The one-side delta sheets of the individual gusset sheets 16 to 19 are adhered with the adhesive 31 to the outer surfaces of the first and third side sheets 7 and 9.

While the first to fourth gusset sheets 16 to 19 are being adhered, the folded states of the first to fourth side sheets 7 to 10 by the first to fourth guide poles 27 and 28 are held to adhere the gusset sheets in the held state.

The adhesions of the gusset sheets hold the shape of the paper container 1A or 1B, and the curved shapes of the two side sheets or the four side sheets of the side sheets 7 to 10.

The first to fourth guide poles 27 and 28 are arranged to confront the four sides 2 to 5 of the bottom sheet 6, and the fifth and sixth guide poles 29 are arranged to confront the vicinities of the four corner portions P1 of the bottom sheet 6, so that the individual guide poles are arranged in a box shape as a whole in a top plan view.

As shown in FIG. 14A to FIG. 14E, the suction cup 32 shrinks downward while sucking the bottom sheet 6 of the extended blank sheet 1A′ or 1B′. At the lower limit of the shrinkage, as shown in FIG. 14E, the suction cup 32 bulges the bottom sheet 6 of the container 1A or 1B downward into the chamber 38 through the opening of the chamber 38 so that the bottom sheet 6 of the completed container 1A or 1B may be brought into the curved state to bulge in the arch or sphere shape into the containing portion 11.

The aforementioned shape to bulge in the arch or sphere shape is so elastically held that the bottom sheet 6 elastically bulges into the containing portion 11 while using the horizontal face as the dead point.

After the suction cup 32 bulged the bottom sheet 6 into the arch or sphere shape, it stops the suction to open the container 1A or 1B so that it restores the extended state by the bellows structure 41.

It is possible to provide the paper container, which can properly form the curved shape to bulge the bottom sheet 6 of the paper container 1A or 1B in the arch or sphere shape into the containing portion 11 and which can form the bottom sheet 6 into the curved shape to concentrate the load of the contents on the two sides or at the four corner portions of the bottom sheet 6 thereby to dispose the paper container 1A or 1B stably and to enhance the strength of the bottom sheet 6 against the weight of the contents.

What is claimed is:

1. A paper container manufacturing method, in which a bottom sheet and four side sheets rising from the bottom sheet form a containing portion opened upward, in which the bottom sheet is formed to have a curved sheet bulging in an arch or sphere shape into said containing portion and in which four gusset sheets are connected to the side sheets adjoining at the four corner portions of said containing portion and folded on the outer surfaces of the paired confronting side sheets and adhered to said surfaces, wherein a block having four side faces for regulating the inner faces of said four side sheets is used to fold the four side sheets of an extended blank sheet of said paper container, as extended four ways from said bottom sheet, downward so as to push the four side sheets onto the four side faces of said block thereby to form said rising state; said four gusset sheets are pushed onto and adhered to the outer surfaces of the confronting paired side sheets in said rising state, thereby to form said containing portion; and said bottom sheet is sucked downward, in the procedure to form said containing portion, by a suction cup mounted in said block, thereby to bend said bottom sheet into a curved state to bulge in the arch or sphere shape into the containing portion.
